(19) United States
(12) Patent Application Publication
(10) Pub. No.: US 2025/0122317 A1
(43) Pub. Date: Apr. 17, 2025

(54) FLUORINE-CONTAINING POLYMER, COMPOSITION, SURFACE TREATMENT AGENT, AND ARTICLE

(71) Applicant: AGC Inc., Tokyo (JP)

(72) Inventors: Yusuke YASU, Tokyo (JP); Shinya TAJIMA, Tokyo (JP)

(73) Assignee: AGC Inc., Tokyo (JP)

(21) Appl. No.: 18/991,283

(22) Filed: Dec. 20, 2024

Related U.S. Application Data
(63) Continuation of application No. PCT/JP2023/021850, filed on Jun. 13, 2023.

(30) Foreign Application Priority Data
Jul. 7, 2022 (JP) 2022-109738

(51) Int. Cl. C08F 214/18; C09D 127/12

(52) U.S. Cl. CPC C08F 214/184; C09D 127/12

(57) ABSTRACT

The present invention provides a fluorine-containing polymer that is capable of forming a coating film having excellent liquid repellency and liquid slippability. Specifically provided is a fluorine-containing polymer containing a Unit A having a fluorine-containing aliphatic ring structure that constitutes the main chain, and a Unit B based on a fluorine-containing monomer b that has at least one type of hetero atom selected from the group consisting of an oxygen atom and a sulfur atom, and does not have a fluorine-containing aliphatic ring structure constituting the main chain, wherein the residual rate of polymerizable carbon-carbon double bonds is not more than 0.5 mol %.

This application is a continuation application of International Application No. PCT/JP2023/021850, filed on Jun. 13, 2023, which claims the benefit of priority of the prior Japanese Patent Application No. 2022-109738, filed on Jul. 7, 2022 in Japan, the content of which is incorporated herein by reference.

### TECHNICAL FIELD

The present invention relates to a fluorine-containing polymer, a composition, a surface treatment agent and an article.

### BACKGROUND ART

Conventionally, liquid repellency (water repellency, oil repellency) has often been imparted to the surfaces of a wide variety of articles. One method of imparting liquid repellency involves applying a surface treatment agent containing a fluorine-containing compound such as a fluorine-containing polymer and a liquid medium to the surface to which liquid repellency is to be imparted, thereby forming a coating film of the fluorine-containing compound. By forming a coating film of the fluorine-containing compound, the surface energy decreases, thus enhancing the liquid repellency.

Further, fluorine-containing polymers having a fluorine-containing aliphatic ring structure within the main chain are amorphous, and can therefore be dissolved in solvents, meaning they are ideal for coating applications.

Patent Documents 1 and 2 disclose fluorine-containing polymers having a unit formed by cyclization polymerization of a perfluoro(allyl vinyl ether) or a perfluoro(butenyl vinyl ether). Further, Patent Documents 1 and 2 also disclose copolymerization with comonomers such as a perfluoro(propyl vinyl ether).

### PRIOR ART LITERATURE

### Patent Documents

Patent Document 1: Japanese Unexamined Patent Application, First Publication No. Hei 01-131214
Patent Document 2: Japanese Unexamined Patent Application, First Publication No. Hei 01-131215

### DISCLOSURE OF INVENTION

### Problems to be Solved by the Invention

However, according to investigations conducted by the inventors of the present invention, when the surface of an article is treated using a polymer obtained by copolymerizing perfluoro(allyl vinyl ether) and perfluoro(propyl vinyl ether) in accordance with the method disclosed in Patent Document 1, satisfactory liquid repellency can sometimes not be obtained.

Moreover, depending on the intended application for the article, imparting the article surface with liquid slippability (water slippability, oil slippability) is sometimes desirable. Liquid slippability describes a state in which liquid droplets readily roll across the surface. However, satisfactory liquid slippability cannot be achieved simply by lowering the surface energy.

The present invention provides a fluorine-containing polymer, a composition and a surface treatment agent that are capable of forming a coating film having excellent liquid repellency and liquid slippability, and also provides an article having excellent liquid repellency and liquid slippability.

### Means for Solving the Problems

The present invention has the following aspects.

[1] A fluorine-containing polymer containing a Unit A having a fluorine-containing aliphatic ring structure that constitutes the main chain, and a Unit B based on a fluorine-containing monomer b that has at least one type of hetero atom selected from the group consisting of an oxygen atom and a sulfur atom, and does not have a fluorine-containing aliphatic ring structure constituting the main chain, wherein
the residual rate of polymerizable carbon-carbon double bonds (C═C) is not more than 0.5 mol %.
   [2] The fluorine-containing polymer according to [1], wherein the Unit A is at least one type of unit selected from the group consisting of units formed by cyclization polymerization of a diene-based fluorine-containing monomer, and units based on a cyclic fluorine-containing monomer.
   [3] The fluorine-containing polymer according to [2], wherein the diene-based fluorine-containing monomer is represented by a Formula ma1 shown below.

CF₂═CF-Q-CF═CF₂ Formula ma1

In the formula, Q represents a perfluoroalkylene group of 1 to 6 carbon atoms which may have an etheric oxygen atom and in which a portion of the fluorine atoms may each be substituted with a halogen atom other than a fluorine atom.

[4] The fluorine-containing polymer according to [3], wherein Q in the Formula ma1 has 2 to 6 carbon atoms.
[5] The fluorine-containing polymer according to any one of [2] to [4], wherein the cyclic fluorine-containing monomer is represented by a Formula ma2 shown below.

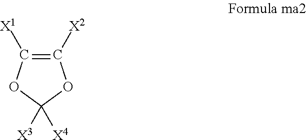

In the formula, X¹, X², X³ and X⁴ each independently represent a fluorine atom, a perfluoroalkyl group which may have an etheric oxygen atom, or a perfluoroalkoxy group which may have an etheric oxygen atom, and X³ and X⁴ may be bonded together to form a ring.

[6] The fluorine-containing polymer according to any one of [1] to [5], wherein the fluorine-containing monomer b is represented by a Formula b1 shown below.

CX^{d}X^{e}═CX^{f}—C_{c}F_{2c}—Y^{c}—R^{F} Formula b1

In the formula, X^{d}, X^{e} and X^{f} each independently represent a fluorine atom or a chlorine atom, provided that at least one of X^{d}, X^{e} and X^{f} represents a fluorine atom, c represents an integer of 0 to 4, Y^{c} represents an oxygen atom or a sulfur atom, and R^{F} represents a perfluoroalkyl group of 1 to 10 carbon atoms.

[7] The fluorine-containing polymer according to any one of [1] to [6], wherein the mass ratio represented by Unit A/Unit B is within a range from 5/95 to 90/10.
[8] The fluorine-containing polymer according to any one of [1] to [7], wherein the total amount of the Unit A and the Unit B, relative to all of the units that constitute the fluorine-containing polymer, is within a range from 10 to 100% by mass.
[9] A composition containing the fluorine-containing polymer according to any one of [1] to [8] and a liquid medium.
[10] A surface treatment agent containing the fluorine-containing polymer according to any one of [1] to [8].
[11] A surface treatment agent composed of the composition according to [9].
[12] An article prepared by coating a substrate with the surface treatment agent according to [10] or [11].
[13] The article according to [12], wherein the substrate is a sheet-like substrate or a fibrous substrate.

### Effects of the Invention

The fluorine-containing polymer of the present invention can form a coating film having excellent liquid repellency and liquid slippability.

The composition of the present invention can form a coating film having excellent liquid repellency and liquid slippability.

The surface treatment agent of the present invention can form a coating film having excellent liquid repellency and liquid slippability.

The article of the present invention has excellent liquid repellency and liquid slippability.

### EMBODIMENTS FOR CARRYING OUT THE INVENTION

Meanings and definitions of the terminology used in the present invention are as follows.

The term “aliphatic ring structure” means a saturated or unsaturated ring structure that has no aromaticity.

The term “fluorine-containing aliphatic ring structure” means an aliphatic ring structure in which a fluorine atom or a fluorine-containing group is bonded to at least a portion of the carbon atoms that constitute the main skeleton of the ring. Examples of the fluorine-containing group include perfluoroalkyl groups, perfluoroalkoxy groups, and ═CF₂ and the like. A substituent other than a fluorine atom or a fluorine-containing group may also be bonded to a portion of the carbon atoms that constitute the main skeleton of the ring.

An “etheric oxygen atom” is a single oxygen atom bonded between two carbon atoms (—C—O—C—).

The expression “residual rate of polymerizable carbon-carbon double bonds” (hereinafter also referred to as the “C═C residual rate”) is the rate (mol %) of polymerizable carbon-carbon double bonds relative to 100 mol % of all the units that constitute the fluorine-containing polymer of the present invention. Details of the method used for measuring the C═C residual rate are as described below in the examples.

The expression “liquid repellency” is a generic term for water repellency and oil repellency.

The expression “liquid slippability” is a generic term for water slippability and oil slippability.

In this description, a compound represented by a Formula ma1 is also referred to as a “Compound ma1”, and a group represented by a Formula q1 is also referred to as a “Group q1”. This also applies to compounds and groups represented by other formulas. A numerical range indicated using the expression “a to b” means a range that includes the numerical values before and after the “to” as the minimum value and maximum value respectively.

### (Fluorine-Containing Polymer)

The fluorine-containing polymer according to one embodiment of the present invention (hereinafter also referred to as the “polymer of the present invention”) contains a Unit A and a Unit B.

The polymer of the present invention may also contain a Unit C described below.

### <Unit A>

The Unit A is a unit having a fluorine-containing aliphatic ring structure. The fluorine-containing aliphatic ring structure constitutes the main chain of the polymer of the present invention. The Unit A is preferably a perfluoro unit.

In the fluorine-containing aliphatic ring structure, the ring skeleton may be a carbon ring structure formed solely from carbon atoms, or may be a hetero ring structure containing an atom (hetero atom) other than a carbon atom within the ring skeleton. Examples of the hetero atom include an oxygen atom or a nitrogen atom or the like. The number of atoms constituting the ring skeleton of the fluorine-containing aliphatic ring structure is preferably within a range from 4 to 7 atoms, and 5 or 6 atoms is particularly preferred. In other words, the aliphatic ring structure is preferably a 4- to 7-membered ring, and a 5- or 6-membered ring is particularly preferred.

In terms of providing superior transparency and solvent solubility, the fluorine-containing aliphatic ring structure is preferably a fluorine-containing aliphatic ring structure with a hetero ring structure having an etheric oxygen atom within the ring skeleton, and is more preferably a fluorine-containing aliphatic ring structure with a hetero ring structure having one or two etheric oxygen atoms within the ring skeleton.

Examples of the fluorine-containing aliphatic ring structure include ring structures in which some or all of the hydrogen atoms in a hydrocarbon ring structure or a hetero ring structure have each been substituted with a fluorine atom.

Among the various possibilities, a fluorine-containing aliphatic ring structure in which some or all of the hydrogen atoms in a hetero ring structure having an etheric oxygen atom in the ring structure have each been substituted with a fluorine atom is preferred, and a fluorine-containing aliphatic ring structure in which some or all of the hydrogen atoms in a hetero ring structure having one or two etheric oxygen atoms in the ring structure have each been substituted with a fluorine atom is particularly desirable.

A perfluoro aliphatic ring structure in which all of the hydrogen atoms in a hydrocarbon ring structure or a hetero ring structure have each been substituted with a fluorine atom is preferred as the fluorine-containing aliphatic ring structure.

The expression that the fluorine-containing aliphatic ring structure “constitutes the main chain” means that at least one carbon atom among the carbon atoms that constitute the ring skeleton of the fluorine-containing aliphatic ring structure is a carbon atom that constitutes part of the main chain of the polymer. Because the two carbon atoms derived from a polymerizable carbon-carbon double bond constitute the main chain of the polymer, the expression that the fluorine-containing aliphatic ring structure “constitutes the main chain” could also be said to mean that one carbon atom or two adjacent carbon atoms that constitute part of the ring of the fluorine-containing aliphatic ring structure are derived from a single polymerizable carbon-carbon double bond.

For example, in those cases where the Unit A is formed by an addition polymerization of a monoene-based monomer, the two carbon atoms derived from the polymerizable carbon-carbon double bond constitute part of the main chain, and either those two carbon atoms are two adjacent carbon atoms within the ring skeleton, or one of the two carbon atoms is a carbon atom within the ring skeleton. Further, in those cases where the Unit A is formed by cyclization polymerization of a diene-based monomer, a total of four carbon atoms derived from the two polymerizable carbon-carbon double bonds constitute part of the main chain, and from two to four of those four carbon atoms constitute the ring skeleton.

Examples of the Unit A include units formed by cyclization polymerization of a diene-based fluorine-containing monomer, and units based on a cyclic fluorine-containing monomer.

A diene-based fluorine-containing monomer is a monomer having two polymerizable carbon-carbon double bond-containing groups and a fluorine atom. In the case of a diene-based fluorine-containing monomer, the Unit A is formed by a cyclization polymerization.

There are no particular limitations on the polymerizable carbon-carbon double bond-containing groups, but vinyl groups, allyl groups, acryloyl groups and methacryloyl groups are preferred. In these polymerizable carbon-carbon double bond-containing groups, some or all of the hydrogen atoms bonded to carbon atoms may each be substituted with a fluorine atom.

A Compound ma1 is preferred as the diene-based fluorine-containing monomer.

CF₂═CF-Q-CF═CF₂ Formula ma1

In the formula, Q represents a perfluoroalkylene group of 1 to 6 carbon atoms which may have an etheric oxygen atom and in which a portion of the fluorine atoms may each be substituted with a halogen atom other than a fluorine atom.

In the Formula ma1, in terms of achieving superior cyclization polymerizability, the number of carbon atoms in the perfluoroalkylene group for Q is preferably two or greater. If the number of carbon atoms is one, then a side reaction in which only one of the CF₂═CF— groups reacts tends to occur more readily during the polymerization, meaning CF₂═CF— groups are more likely to be retained in the polymer. On the other hand, in terms of achieving superior stability of the resulting polymer, the number of carbon atoms in the perfluoroalkylene group is preferably not more than 6, and more preferably 3 or fewer. The perfluoroalkylene group is preferably either linear or branched, and a linear group is particularly desirable.

In the perfluoroalkylene group, a portion of the fluorine atoms may each be substituted with a halogen atom other than a fluorine atom. Examples of the halogen atom other than a fluorine atom include a chlorine atom or a bromine atom.

The perfluoroalkylene group may have an etheric oxygen atom.

A perfluoroalkylene group having an etheric oxygen atom is preferred as Q. In such cases, the etheric oxygen atom in the perfluoroalkylene group may exist at one terminal of the perfluoroalkylene group, etheric oxygen atoms may exist at both terminals of the perfluoroalkylene group, or the etheric oxygen atom may exist between carbon atoms of the perfluoroalkylene group. In terms of the cyclization polymerizability, the etheric oxygen atom preferably exists at one terminal of the perfluoroalkylene group.

Q is preferably a Group q1 or a Group q2.

—(CR¹¹R¹²)ₕ— Formula q1

—(CR¹³R¹⁴)ᵢO(CR¹⁵R¹⁶)ⱼ— Formula q2

In these formulas, R¹¹, R¹², R¹³, R¹⁴, R¹⁵ and R¹⁶ each independently represent a fluorine atom, a chlorine atom, a trifluoromethyl group, or a trifluoromethoxy group. Further, h represents an integer of 2 to 4, and the plurality of R¹¹ and R¹² groups may be the same or different. Moreover, i and j each represent an integer of 0 to 3, provided that i+j is an integer of 1 to 3, and when i is 2 or 3, the plurality of R¹³ and R¹⁴ groups may be the same or different, and when j is 2 or 3, the plurality of R¹¹ and R¹⁶ groups may be the same or different.

In the Group q1, h is preferably 2 or 3. It is preferable either that all of the R¹¹ and R¹² groups are fluorine atoms, or that all except one or two of the R¹¹ and R¹² groups are fluorine atoms.

In the Group q2, it is preferable that i represents 0 and j represents an integer of 1 to 3. In terms of achieving superior cyclization polymerizability, j is more preferably either 2 or 3, and a value of 2 is particularly preferred. It is preferable either that all of the R¹⁵ and R¹⁶ groups are fluorine atoms, or that all except one or two of the R¹⁵ and R¹⁶ groups are fluorine atoms.

Specific examples of the Compound ma1 include the compounds shown below.

CF₂═CFOCF₂CF═CF₂

CF₂═CFOCF(CF₃)CF═CF₂

CF₂═CFOCF₂CF₂CF═CF₂

CF₂═CFOCF₂CF(CF₃)CF═CF₂

CF₂═CFOCF(CF₃)CF₂CF═CF₂

CF₂═CFOCFC1CF₂CF═CF₂

CF₂═CFOCCl₂CF₂CF═CF₂

CF₂═CFOCF₂OCF═CF₂

CF₂═CFOC(CF₃)₂OCF═CF₂

CF₂═CFOCF₂CF(OCF₃)CF═CF₂

CF₂═CFCF₂CF═CF₂

CF₂═CFCF₂CF₂CF═CF₂

CF₂═CFCF₂OCF₂CF═CF₂

Examples of cyclic fluorine-containing monomers include monomers containing a fluorine-containing aliphatic ring, and having a polymerizable carbon-carbon double bond between carbon atoms that constitute the fluorine-containing aliphatic ring, and monomers containing a fluorine-containing aliphatic ring, and having a polymerizable carbon-carbon double bond between a carbon atom that constitutes part of the fluorine-containing aliphatic ring and a carbon atom outside of the fluorine-containing aliphatic ring.

A Compound ma2 or a Compound ma3 is preferred as the cyclic fluorine-containing monomer.

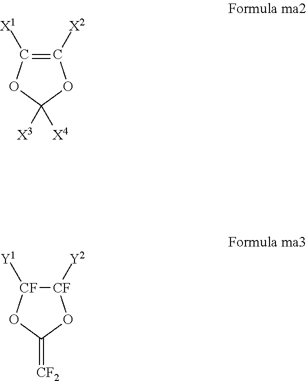

In the formulas, X¹, X², X³, X⁴, Y¹ and Y² each independently represent a fluorine atom, a perfluoroalkyl group which may have an etheric oxygen atom, or a perfluoroalkoxy group which may have an etheric oxygen atom, and X³ and X⁴ may be bonded together to form a ring.

In the Formula ma2 and the Formula ma3, the perfluoroalkyl group for X¹, X², X³, X⁴, Y¹ or Y² preferably has 1 to 7 carbon atoms, more preferably 1 to 5 carbon atoms, and particularly preferably 1 to 4 carbon atoms. The perfluoroalkyl group is preferably linear or branched, and a linear group is particularly preferred. The perfluoroalkyl group is preferably a trifluoromethyl group, pentafluoroethyl group, or heptafluoropropyl group or the like, and a trifluoromethyl group is particularly desirable.

Examples of the perfluoroalkoxy group for X¹, X², X³, X⁴, Y¹ or Y² include groups in which an oxygen atom (—O—) is bonded to one of the above perfluoroalkyl groups, and a trifluoromethoxy group is particularly desirable.

When the number of carbon atoms in the perfluoroalkyl group or perfluoroalkoxy group is two or greater, an etheric oxygen atom (—O—) may be interposed between carbon atoms of the perfluoroalkyl group or perfluoroalkoxy group.

In the Formula ma2, X¹ is preferably a fluorine atom.

X² is preferably a fluorine atom, a trifluoromethyl group or a perfluoroalkoxy group of 1 to 4 carbon atoms, and a fluorine atom or a trifluoromethoxy group is particularly desirable.

X³ and X⁴ each preferably represent a fluorine atom or a perfluoroalkyl group of 1 to 4 carbon atoms, and a fluorine atom or a trifluoromethyl group is particularly desirable.

X³ and X⁴ may be bonded together to form a ring. The number of atoms constituting the ring skeleton of this ring is preferably from 4 to 7 atoms, and more preferably 5 or 6 atoms.

In the Formula ma3, Y¹ and Y² each preferably represent a fluorine atom, a perfluoroalkyl group of 1 to 4 carbon atoms, or a perfluoroalkoxy group of 1 to 4 carbon atoms, and a fluorine atom or a trifluoromethyl group is particularly desirable.

Specific examples of preferred compounds for the Compound ma2 include Compounds ma21 to ma25 shown below. In terms of obtaining a fluorine-containing polymer with particularly superior liquid repellency and liquid slippability, the Compound ma21 is preferred.

Specific examples of preferred compounds for the Compound ma3 include Compounds ma31 and ma32 shown below.

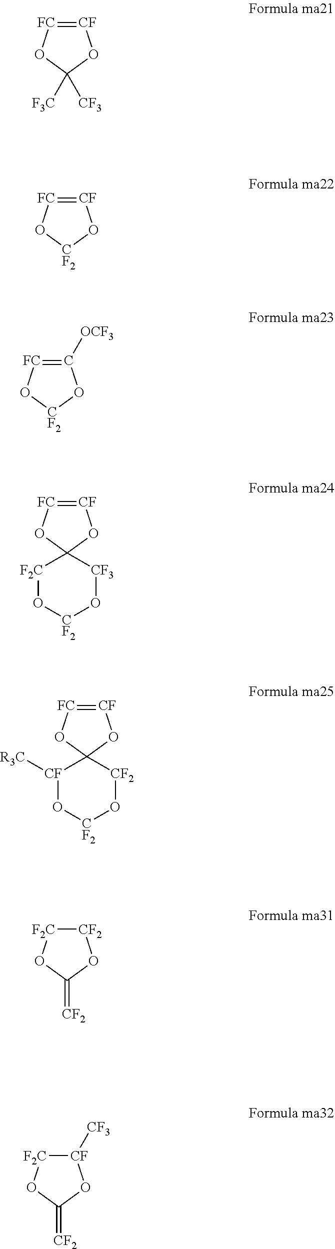

The Unit A is preferably at least one type of unit selected from the group consisting of Units a11 to a16 described below.

The Units a11 to a14 are units formed by cyclization polymerization of the Compound ma1. At least one of the Units among a11 to a14 is produced by cyclization polymerization of the Compound ma1. At this time, among the Units a11 to a14, those units having a structure in which the number of atoms that constitute the ring skeleton of the fluorine-containing aliphatic ring is either 5 or 6 are produced most readily. A polymer containing two or more types of these units is sometimes produced. In other words, a Compound ma1 having a structure in which, within the Units a11 to a14 described below, the number of atoms constituting the ring skeleton, including the atoms within Q, is either 5 or 6 is preferred.

A Unit a15 shown below is a unit formed from the Compound ma2, and a Unit a16 described below is a unit formed from the Compound ma3.

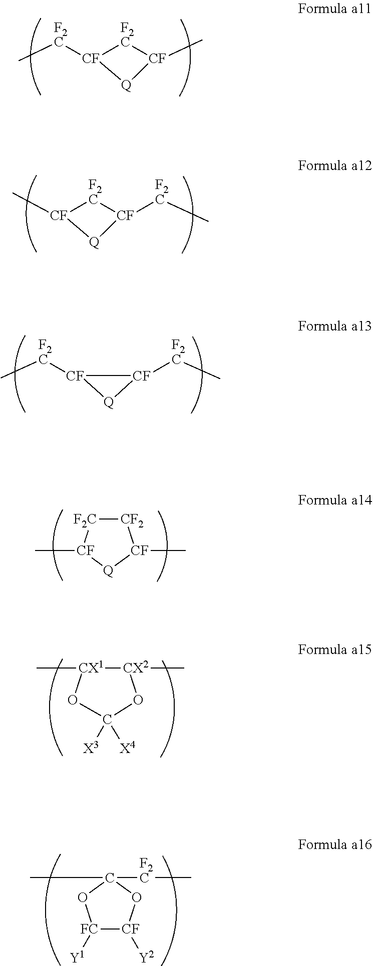

In terms of exhibiting superior chemical stability, a unit formed by cyclization polymerization of a diene-based fluorine-containing monomer is preferred as the Unit A. In terms of obtaining a fluorine-containing polymer having particularly superior liquid repellency and liquid slippability, a unit based on a cyclic fluorine-containing monomer is preferred as the Unit A. Although the reasons for this preference are not entirely clear, it is thought that a unit based on a cyclic fluorine-containing monomer may lower the critical surface tension of the coating film.

The Unit A in the polymer of the present invention may be a single type of unit, or a combination of two or more types of unit.

### <Unit B>

The Unit B is a unit based on a fluorine-containing monomer b that has at least one type of hetero atom selected from the group consisting of an oxygen atom and a sulfur atom, and does not have a fluorine-containing aliphatic ring structure constituting the main chain.

In terms of achieving superior liquid repellency, the fluorine-containing monomer b preferably has a perfluoroalkyl group. The perfluoroalkyl group may be linear or branched. In terms of ease of availability, the perfluoroalkyl group preferably has not more than 10 carbon atoms, and more preferably 4 or fewer carbon atoms.

The fluorine-containing monomer b is preferably a perfluoro monomer.

In terms of achieving even more superior liquid repellency, a fluorine-containing monomer b1 is preferred as the fluorine-containing monomer b.

CX^{d}X^{e}═CX^{f}—C_{c}F_{2c}—Y^{c}—R^{F} Formula b1

In the formula, X^{d}, X^{e} and X^{f} each independently represent a fluorine atom or a chlorine atom, provided that at least one of X^{d}, X^{e} and X^{f} represents a fluorine atom, c represents an integer of 0 to 4, Y^{c} represents an oxygen atom or a sulfur atom, and R^{F} represents a perfluoroalkyl group of 1 to 10 carbon atoms.

Examples of CX^{d}X^{e}═CX^{f}— include CF₂═CF— and CF₂═CCl—. Of these, in terms of achieving superior copolymerization reactivity with the monomer that forms the Unit A, CF₂═CF— is preferred.

Further, c is preferably 0 or 1. When c is 0, the carbon atom to which X^{f} is bonded is bonded directly to Y^{c}.

The perfluoroalkyl group for R^{F} is the same as described above.

Specific examples of the fluorine-containing monomer b1 include perfluoro(methyl vinyl ether), perfluoro(ethyl vinyl ether), perfluoro(propyl vinyl ether), perfluoro(butyl vinyl ether), and perfluoro(pentyl vinyl ether).

The Unit B in the polymer of the present invention may be a single type of unit, or a combination of two or more types of unit.

### <Unit C>

The Unit C is a unit other than the Unit A and the Unit B.

There are no particular limitations on the Unit C, which may be any unit based on a monomer that can undergo copolymerization with the monomer that forms the Unit A and the monomer that forms the Unit B. Examples include units based on fluorine-containing olefins such as tetrafluoroethylene, and units based on halo-olefins such as vinylidene chloride.

A perfluoro unit is preferred as the Unit C.

The Unit C in the polymer of the present invention may be a single type of unit, or a combination of two or more types of unit.

In the polymer of the present invention, the mass ratio represented by Unit A/Unit B is preferably within a range from 5/95 to 90/10, more preferably from 15/85 to 80/20, particularly preferably from 30/70 to 70/30, and most preferably from 55/45 to 70/30. The ratio may also be within a range from 55/45 to 75/25. Provided the Unit A/Unit B ratio is at least as high as the above lower limit, the liquid slippability of the coating film and the heat resistance of the polymer of the present invention are more superior, and provided the ratio is not higher than the above upper limit, the liquid repellency of the coating film is particularly superior.

The total amount of the Unit A and the Unit B, relative to a11 of the units that constitute the polymer of the present invention, is preferably at least 10% by mass, more preferably at least 30% by mass, particularly preferably at least 70% by mass, and most preferably 100% by mass. In other words, it is particularly desirable that the polymer of the present invention is composed solely of the Unit A and the Unit B. Provided the total amount of the Unit A and the Unit B is at least as large as the above lower limit, the coating properties and liquid repellency are excellent.

The C═C residual rate in the polymer of the present invention is typically not more than 0.5 mol %, is preferably not more than 0.3 mol %, and may be 0 mol %. In those cases where the amounts of the Unit A and the Unit B are the same, a lower C═C residual rate tends to result in superior liquid repellency and liquid slippability. Further, the polymer also tends to exhibit excellent heat resistance, including better resistance to coloration upon heating, and higher values for the weight loss temperature and the glass transition temperature.

The weight average molecular weight (Mw) of the polymer of the present invention is preferably within a range from 3,000 to 1,000,000, more preferably from 10,000 to 500,000, and particularly preferably from 10,000 to 100,000. Provided Mw is at least as large as the above lower limit, the ease of recovery of the polymer and the film strength are superior, whereas provided Mw is not greater than the above upper limit, the solubility in liquid mediums and the moldability are superior.

The weight average molecular weight is a polymethyl methacrylate (hereinafter also abbreviated as PMMA) equivalent value measured by gel permeation chromatography. Details regarding the measurement method for the weight average molecular weight are as described below in the following examples.

The 5% thermal weight loss temperature (5% Td) for the polymer of the present invention is preferably at least 300° C., more preferably at least 350° C., and particularly preferably 400° C. or higher. Provided the 5% Td value is at least as high as the above lower limit, the polymer can be used in applications requiring heat resistance.

The higher the 5% Td value the better, and although there are no particular limitations on the upper limit, the upper limit may be, for example, 500° C.

The 5% Td value can be determined by a thermogravimetric differential thermal analysis measurement. Details regarding the measurement method for the 5% Td value are as described below in the following examples.

The glass transition temperature (Tg) of the polymer of the present invention is preferably at least 25° C., more preferably at least 30° C., and particularly preferably 35° C. or higher. Provided the Tg value is at least as high as the above lower limit, the polymer can be used in applications that require heat resistance. Further, superior liquid slippability manifests more readily at values close to room temperature.

The higher the Tg value the better, and although there are no particular limitations on the upper limit, the upper limit may be, for example, 100° C.

The Tg value can be determined by a differential scanning calorimetry measurement. Details regarding the measurement method for the Tg value are as described below in the following examples.

### (Method for Producing Polymer)

The polymer of the present invention can be obtained, for example, by polymerizing a monomer component that includes a fluorine-containing monomer that forms the Unit A and the fluorine-containing monomer b.

The monomer component may also include a monomer that forms the Unit C.

The fluorine-containing monomer that forms the Unit A, the fluorine-containing monomer b, and the monomer that forms the Unit C may each be produced using conventional production methods. In the case of commercially available monomers, commercially available products may be used.

The amount of each monomer relative to the total mass of the monomer component may be set in accordance with the amount of each unit relative to the total of a11 the units that constitute the polymer of the present invention.

The polymerization of the monomer component is preferably conducted in the presence of a polymerization initiator. If required, a chain transfer agent, an emulsifier and/or a dispersion stabilizer or the like may also be added.

Examples of the polymerization method include conventional polymerization methods such as solution polymerization methods, suspension polymerization methods, emulsion polymerization methods, and bulk polymerization methods. The polymerization temperature is, for example, within a range from 20 to 80° C.

In the production of the polymer of the present invention, production is conducted so that the C═C residual rate in the obtained polymer is not more than 0.5 mol %.

Examples of the method used for ensuring that the C═C residual rate is not more than 0.5 mol % include methods in which a diene-based fluorine-containing monomer (for example, a Compound ma1 in which Q contains 2 to 6 carbon atoms), which is less likely to undergo a side reaction in which only one of the CF₂═CF groups reacts during the polymerization, is used as the fluorine-containing monomer that forms the Unit A, and methods in which a cyclic fluorine-containing monomer is used as the fluorine-containing monomer that forms the Unit A. In those cases where a diene-based fluorine-containing monomer (for example, CF₂═CFOCF₂CF═CF₂) which is likely to undergo a side reaction in which only one of the CF₂═CF groups reacts during the polymerization is used, the C═C residual rate can be lowered by lowering the reaction temperature (for example, a temperature of less than 40° C.) to suppress side reactions.

The polymer of the present invention described above contains the Unit A and the Unit B and has a C═C residual rate of less than 0.5 mol %, and can therefore form a coating film having excellent liquid repellency and liquid slippability. Further, the polymer of the present invention also exhibits superior heat resistance, and a coating film containing the polymer also has excellent heat resistance.

When residual polymerizable carbon-carbon double bonds are retained in the polymer, those polymerizable carbon-carbon double bond may undergo oxidative degradation to form hydroxyl groups and carboxy groups under heating or the like. It is thought that by ensuring that the C═C residual rate is less than 0.5 mol %, hydroxyl groups and carboxy groups are either not produced, or are produced in only very small amounts, enabling superior liquid repellency and liquid slippability to be achieved.

There are no particular limitations on the applications for the polymer of the present invention, and examples of those applications include surface treatment agents, protective films on resins, and cladding materials for optical fibers.

Because of the effects described above, the polymer of the present invention is ideal as a surface treatment agent. By applying a surface treatment agent containing the polymer of the present invention to a substrate, thus forming a coating film containing the polymer of the present invention, excellent liquid repellency and liquid slippability can be imparted.

The water contact angle of the surface of a coating film containing the polymer of the present invention is preferably at least 105°, more preferably at least 110°, and particularly preferably 115° or greater. Provided the water contact angle is at least 105°, the coating film is suitable for applications requiring water repellency.

The n-hexadecane contact angle of the surface of a coating film containing the polymer of the present invention is preferably at least 55°, more preferably at least 60°, and particularly preferably 650 or greater. Provided the n-hexadecane contact angle is at least 55°, the coating film is suitable for applications requiring oil repellency.

The water sliding angle of the surface of a coating film containing the polymer of the present invention is preferably less than 45°, more preferably less than 40°, and particularly preferably less than 25°. Provided the water sliding angle is less than 45°, the coating film is suitable for applications requiring water slippability.

The n-hexadecane drop angle of the surface of a coating film containing the polymer of the present invention is preferably less than 45°, more preferably less than 40°, and particularly preferably less than 25°. Provided the n-hexadecane slidingp angle is less than 45°, the coating film is suitable for applications requiring oil slippability.

The water contact angle, the n-hexadecane contact angle, the water sliding angle, and the n-hexadecane sliding angle may each be measured using the methods described below in the following examples.

### (Composition)

The composition according to one embodiment of the present invention (hereinafter also referred to as the “composition of the present invention”) contains the polymer of the present invention and a liquid medium.

The composition of the present invention may also contain one or more other components besides the polymer of the present invention and the liquid medium, provided this does not impair the effects of the present invention.

Examples of the liquid medium include protic solvents and aprotic solvents. A “protic solvent” is a solvent that has proton donor ability. An “aprotic solvent” is a solvent that does not have a proton donor ability.

The liquid medium is preferably capable of dissolving at least the polymer of the present invention. A fluorine-containing solvent is preferred as the liquid medium.

Examples of protic fluorine-containing solvents include the following solvents:
fluorine-containing alcohols such as trifluoroethanol, 2,2,3,3,3-pentafluoro-1-propanol, 2-(perfluorobutyl)ethanol, 2-(perfluorohexyl)ethanol, 2-(perfluorooctyl)ethanol, 2-(perfluorodecyl)ethanol, 2-(perfluoro-3-methybutyl)ethanol, 2,2,3,3-tetrafluoro-1-propanol, 2,2,3,3,4,4,5,5-octafluoro-1-pentanol, 2,2,3,3,4,4,5,5,6,6,7,7-dodecafuoro-1-heptanol, 2,2,3,3,4,4,5,5,6,6,7,7,8,8,9,9-hexadecafluoro-1-nonanol, 1,1,1,3,3,3-hexafluoro-2-propanol, and 1,3,3,4,4,4-hexafluoro-2-butanol; fluorine-containing carboxylic acids such as trifluoroacetic acid, perfluoropropanoic acid, perfluorobutanoic acid, perfluoropentanoic acid, perfluorohexanoic acid, perfluoroheptanoic acid, perfluorooctanoic acid, perfluorononanoic acid, perfluorodecanoic acid, 1,1,2,2-tetrafluoropropanoic acid, 1,1,2,2,3,3,4,4-octafluoropentanoic acid, 1,1,2,2,3,3,4,4,5,5,6,6,7,7-dodecafluoroheptanoic acid, and 1,1,2,2,3,3,4,4,5,5,6,6,7,7,8,8,9,9-hexadecafluorononanoic acid; and fluorine-containing sulfonic acids such as trifluoromethanesulfonic acid and heptadecafluorooctanesulfonic acid.

Examples of aprotic fluorine-containing solvents include the following solvents:
polyfluoro aromatic compounds such as 1,4-bis(trifluoromethyl)benzene, polyfluorotrialkylamine compounds such as perfluorotributylamine, polyfluorocycloalkane compounds such as perfluorodecalin, polyfluoro cyclic ether compounds such as perfluoro(2-butyltetrahydrofuran), as well as perfluoropolyethers, polyfluoroalkane compounds, and hydrofluoro ethers (HFE) and the like.

Examples of the HFE compounds include CF₃CH₂OCF₂CF₂H (AE-3000, a product name, manufactured by AGC Chemicals Company), C₄F₉OCH₃ (Novec-7100, a product name, manufactured by 3M Company), C₄F₉OC₂H₅(Novec-7200, a product name, manufactured by 3M Company), and C₂F₅CF(OCH₃)C₃F₇(Novec-7300, a product name, manufactured by 3M Company).

One of these liquid medium may be used alone, or a combination of two or more liquid mediums may be used. Further, a wide range of compounds other than those listed above may also be used as the liquid medium.

In terms of being a good solvent for the polymer of the present invention, an aprotic fluorine-containing solvent is preferred as the liquid medium.

A combination of an aprotic fluorine-containing solvent and a protic non-fluorine-containing solvent (such as methanol) may also be used. In the case of such a combination, the protic non-fluorine-containing solvent preferably represents from 1 to 20% by mass of the total solvent mass.

From the viewpoint of enabling ready formation of a uniform coating film upon application of the composition of the present invention, the boiling point of the liquid medium is preferably within a range from 65 to 220° C., and particularly preferably from 70 to 220° C.

The amount of the polymer of the present invention in the composition of the present invention, relative to the total mass of the solid fraction in the polymer of the present invention, is preferably at least 1% by mass, more preferably at least 10% by mass, particularly preferably at least 30% by mass, and may be 100% by mass. Provided the amount of the polymer of the present invention is at least as large as the above lower limit, the liquid repellency and liquid slippability of the coating film are superior.

The solid fraction is the combined total of a11 of the components excluding the liquid medium.

The amount of the liquid medium is set in accordance with the solid fraction concentration of the composition of the present invention. For example, the amount of the liquid medium relative to the total mass of the composition of the present invention may be within a range from 60 to 99.9% by mass.

The solid fraction concentration of the composition of the present invention may be set appropriately in accordance with factors such as the application method used for the composition of the present invention and the desired thickness for the formed coating film, and for example, relative to the total mass of the composition of the present invention, may be within a range from 0.1 to 40% by mass.

The composition of the present invention can be obtained, for example, by mixing the polymer of the present invention, the liquid medium, and any other components as required. In the method for producing the polymer described above, in those cases where the monomer component is polymerized in the presence of a liquid medium (such as a solvent or dispersion medium or the like), the obtained reaction liquid may be used, as is, as the composition of the present invention. Alternatively, some or a11 of the liquid medium of the reaction liquid may be substituted, or other components may be added as necessary, to obtain the composition of the present invention.

Because the composition of the present invention described above contains the polymer of the present invention, a coating film having superior liquid repellency and liquid slippability can be formed. Further, the coating film formed from the composition of the present invention also exhibits excellent heat resistance.

The water contact angle of the surface of a coating film formed from the composition of the present invention is preferably at least 105°, more preferably at least 110°, and particularly preferably 1150 or greater. Provided the water contact angle is at least 105°, the coating film is suitable for applications requiring water repellency.

The n-hexadecane contact angle of the surface of a coating film formed from the composition of the present invention is preferably at least 55°, more preferably at least 60°, and particularly preferably 65° or greater. Provided the n-hexadecane contact angle is at least 55°, the coating film is suitable for applications requiring oil repellency.

The water sliding angle of the surface of a coating film formed from the composition of the present invention is preferably less than 45°, more preferably less than 40°, and particularly preferably less than 25°. Provided the water sliding angle is less than 45°, the coating film is suitable for applications requiring water slippability.

The n-hexadecane sliding angle of the surface of a coating film formed from the composition of the present invention is preferably less than 45°, more preferably less than 40°, and particularly preferably less than 25°. Provided the n-hexadecane sliding angle is less than 45°, the coating film is suitable for applications requiring oil slippability.

There are no particular limitations on the applications for the composition of the present invention, and examples of those applications include surface treatment agents, materials for forming protective films on resins, and cladding materials for optical fibers.

Among the above applications, the composition of the present invention is ideal as a surface treatment agent. By applying a surface treatment agent composed of the composition of the present invention to a substrate and forming a coating film containing the polymer of the present invention, the coating film can be imparted with excellent liquid repellency and liquid slippability.

### (Article)

The article according to one embodiment of the present invention (hereinafter also referred to as the “article of the present invention”) is an article prepared by applying a surface treatment agent containing the polymer of the present invention to a substrate.

The surface treatment agent may be composed of the polymer of the present invention, or may be composed of the composition of the present invention. In terms of ease of application, the surface treatment agent is preferably composed of the composition of the present invention.

The article of the present invention can be obtained by applying the surface treatment agent to a substrate, and then conducting drying if required. This process forms a coating film containing the polymer of the present invention on the substrate.

There are no particular limitations on the application method used, and conventional methods may be employed. For example, in those cases where the surface treatment agent is composed of the composition of the present invention, a conventional wet coating method or casting method may be used.

The amount applied of the surface treatment agent, expressed as a solid fraction mass per unit of surface area of the substrate (g/m²), is preferably within a range from 0.1 to 40.0 (g/m²), and more preferably from 0.3 to 20.0 (g/m²). Provided the amount applied is at least as large as the above lower limit, the liquid repellency and liquid slippability are more superior. Further, provided the amount applied is not more than the above upper limit, the coating stability is more superior.

The drying may be any process that enables removal of the liquid medium, and may involve drying under heat, or drying without heat. The drying temperature is preferably within a range from 20 to 80° C., and more preferably from 30 to 80° C.

There are no particular limitations on the material that constitutes the substrate, and examples include resins (such as polyimide, imide, polypropylene, polyethylene terephthalate, polycarbonate, cycloolefin polymers, acrylic resins, polytetrafluoroethylene, and tetrafluoroethylene-ethylene copolymers), papers, wooden materials, leather, glass, metals (such as silicon, stainless steel, aluminum, copper, and alloys of these metals), stone, concrete, and plaster. A combination of two or more materials may also be used. Among these possibilities, in terms of achieving superior adhesion of the coating film of the composition of the present invention to the substrate, polytetrafluoroethylene is preferred.

There are also no particular limitations on the shape of the substrate, and examples include a11 manner of shapes including sheet-like shapes, fibrous shapes, tube-like shapes, and various other shapes. Among these possibilities, in terms of ease of application to the substrate, a sheet-like shape or fibrous shape is preferred.

The substrate may be porous or non-porous.

The substrate is preferably a substrate that requires either one or both of liquid repellency and liquid slippability.

Specific examples of the substrate include fibers (such as natural fibers, synthetic fibers, mixed yarn fibers, and glass fibers), fabrics (such as woven fabrics, knitted fabrics, and non-woven fabrics), textile products (including clothing articles (such as sportswear, coats, jackets, work clothing, and uniforms), bags, and industrial materials), and separation membranes (such as filtration membranes, air filters, and ion exchange membranes).

### EXAMPLES

The present invention is described below in further detail using a series of examples and comparative examples, but the present invention is not limited to the following examples, provided the scope of the invention is not exceeded.

Examples 1 to 11 are examples of the present invention, and Examples 12 to 15 are comparative examples.
AVE: perfluoro(allyl vinyl ether)
BVE: perfluoro(butenyl vinyl ether)
PPVE: perfluoro(propyl vinyl ether)
PDD: perfluoro(2,2-dimethyl-1,3-dioxole)
Novec-7200: manufactured by 3M Company, product name: Novec-7200, a mixed liquid of ethyl nonafluoroisobutyl ether and ethyl nonafluorobutyl ether
Novec-7300: manufactured by 3M Company, product name: Novec-7300, 1,1,1,2,2,3,4,5,5,5-decafluoro-3-methoxy-4-(trifluoromethyl)-pentane
n-H.D.: normal-hexadecane (manufactured by Tokyo Chemical Industry Co., Ltd.)

### (Evaluation Methods)

### <Amount of Each Unit in Fluorine-Containing Polymer>

The amounts of each unit in fluorine-containing polymer were calculated on the basis of the results of a ¹⁹F-NMR measurement performed using a nuclear magnetic resonance device (AVANCE NEO 400, manufactured by Bruker Corporation).

A fluorine-containing polymer for which the mass had been measured in advance was dissolved in perfluorobenzene (manufactured by Tokyo Chemical Industry Co., Ltd.) to produce a measurement sample, and a ¹⁹F-NMR measurement was conducted.

The integral ratio of the peaks attributable to the fluorine atoms of the —CF₂O— group of the BVE or AVE units and the trifluoromethyl group of the PPVE units in the fluorine-containing polymer was determined and converted to a mass ratio, thus enabling the amounts of the BVE or AVE unit and the PPVE unit within the fluorine-containing polymer to be determined.

### <C═C Residual Rate in Fluorine-Containing Polymer>

The C═C residual rate for each fluorine-containing polymer was calculated on the basis of the results of a ¹⁹F-NMR measurement performed using a nuclear magnetic resonance device (AVANCE NEO 400, manufactured by Bruker Corporation).

A fluorine-containing polymer for which the mass had been measured was dissolved in perfluorobenzene to produce a measurement sample, and a ¹⁹F-NMR measurement was conducted.

The integral ratio between the fluorine atoms derived from perfluorovinyl groups (—CF═CF₂) in the fluorine-containing polymer and the total of a11 fluorine atoms within the fluorine-containing polymer was determined and converted to a molar ratio, thus enabling the C═C residual rate within the fluorine-containing polymer to be determined.

### <Weight Average Molecular Weight of Fluorine-Containing Polymer>

The weight average molecular weight of each fluorine-containing polymer was measured using a gel permeation chromatograph (GPC) (device name: HLC-8420GPC, manufactured by Tosoh Corporation). A mixed solution prepared by mixing Novec-7300 and 1,1,1,3,3,3-hexafluoro-2-propanol (manufactured by FUJIFILM Wako Pure Chemical Corporation) in a volume ratio of 90/10 was used as the mobile phase. The weight average molecular weight of the fluorine-containing polymer was determined with the measurement results for standard substances of polymethyl methacrylate (manufactured by Agilent Technologies, Inc.).

### <Coloration of Solid Fraction of Fluorine-Containing Polymer>

In the synthesis examples for the various fluorine-containing polymers described below, a dried product obtained by subjecting the aggregated solid fraction to vacuum drying at 65° C. was inspected visually for the presence or absence of coloration. A product with no coloration appears white.

### <Weight Loss Temperature for Fluorine-Containing Polymer>

The 5% weight loss temperature (5% Td) of fluorine-containing polymers were measured using a thermogravimetric differential thermal analysis measurement (TG-DTA) device (device name: STA7000, manufactured by Hitachi High-Tech Corporation) under air atmosphere. A scanned temperature range and a scanning rate were set from 200 to 550° C., and 10° C./minute, respectively.

The measurement result for the 5% Td was evaluated against the following criteria. A higher 5% Td value indicates superior heat resistance.

### [5% Td Evaluation Criteria]

B: 5% Td of 400° C. or higher
C: 5% Td of at least 300° C. but less than 400° C.
D: 5% Td of less than 300° C.

### <Glass Transition Temperature of Fluorine-Containing Polymer>

The glass transition temperature (Tg) of fluorine-containing polymers were measured using a differential scanning calorimetry (DSC) device (device name: DSC204 F1 Phoenix, manufactured by The NETZSCH Group). The measurements were conducted across three cycles of temperature rise and temperature fall under conditions including a scanned temperature range of −50° C. to 200° C. and a scanning rate of 10° C./minute. The measurement result from the second cycle was used as the Tg of the fluorine-containing polymer.

The measurement result for Tg was evaluated against the following criteria. A higher Tg value indicates superior heat resistance.

### [Tg Evaluation Criteria]

B: Tg of 30° C. or higher
C: Tg of at least 25° C. but less than 30° C.
D: Tg of less than 25° C.

### <Liquid Repellency of Coating Film>

### [Water Contact Angle]

A suitable quantity of each prepared surface treatment agent was dripped onto a glass substrate, which was subsequently rotated at 500 rpm for 30 seconds on a spin coater to coat entirely on the substrate. The coated substrate was then heated at 110° C. for 30 minutes, then coating film of the fluorine-containing polymer was formed.

In an environment at 25° C. and with the coating film secured in a horizontal state, a water droplet of about 2 μL was dripped onto the coating film, and a contact angle meter (device name: SA-301, manufactured by Kyowa Interface Science Co., Ltd.) was used to measure the contact angle.

The measurement result for the water contact angle was evaluated against the following criteria. A larger water contact angle indicates superior water repellency.

### [Water Contact Angle Evaluation Criteria]

A: water contact angle of 115° or greater
B: water contact angle of at least 110° but less than 115°
C: water contact angle of at least 105° but less than 110°
D: water contact angle of less than 105°

### [n-H.D. Contact Angle]

With the exception of using n-H.D. instead of water, the contact angle was measured in the same manner as that described above for the water contact angle.

The measurement result for the n-H.D. contact angle was evaluated against the following criteria. A larger n-H.D. contact angle indicates superior oil repellency.

### [n-H.D. Contact Angle Evaluation Criteria]

A: n-H.D. contact angle of 65° or greater
B: n-H.D. contact angle of at least 60° but less than 65°
C: n-H.D. contact angle of at least 55° but less than 60°
D: n-H.D. contact angle of less than 550

### <Liquid Slippability of Coating Film>

### [Water Sliding Angle]

Using the same procedure as that described for the liquid repellency evaluations, a coating film of the fluorine-containing polymer was formed on a glass substrate.

In an environment at 25° C. and with the coating film secured in a horizontal state, a water droplet of about 2 μL was dripped onto the coating film, and a contact angle meter (device name: SA-301, manufactured by Kyowa Interface Science Co., Ltd.) was used to tilt the coating film from 0° to 900 relative to the horizontal plane at a rate of 1°/second. The tilt angle at which the water droplet started to slip downward, namely the sliding angle, was measured.

The measurement result for the water sliding angle was evaluated against the following criteria. A smaller water drop angle indicates superior water slippability.

### [Water Sliding Angle Evaluation Criteria]

A: water sliding angle of less than 25°
B: water sliding angle of at least 25° but less than 40°
C: water sliding angle of at least 40° but less than 450
D: water sliding angle of at least 45°, or the droplet did not fall even after tilting to 90°

### [n-H.D. Sliding Angle]

With the exception of using approximately 3 μL of n-H.D. instead of water, the sliding angle was measured in the same manner as that described above for the water sliding angle.

The measurement result for the n-H.D. sliding angle was evaluated against the following criteria. A smaller n-H.D. sliding angle indicates superior oil slippability.

### [n-H.D. Drop Angle Evaluation Criteria]

A: n-H.D. sliding angle of less than 25°
B: n-H.D. sliding angle of at least 25° but less than 40°
C: n-H.D. sliding angle of at least 40° but less than 45°
D: n-H.D. sliding angle of at least 45°, or the droplet did not fall even after tilting to 90°

### Synthesis Example 1

A pressure-resistant glass reactor with an internal capacity of 100 mL was charged with 36.0 g of BVE, 4.0 g of PPVE, and 0.75 g of a solution mixture of 1,1,2,2-tetrafluoroethyl-2,2,2-trifluoroethyl ether (product name: AE-3000, manufactured by AGC Co., Ltd.) and diisopropyl peroxydicarbonate (product name: PEROYL IPP, manufactured by NOF Corporation), and following insertion of a magnetic stirring bar, the liquid phase was subjected to freeze-pump-thaw cycling. About solution mixture of AE3000 and IPP as an initiator, the mass ratio of AE3000 and IPP is 80/20, and hereinafter this solution is referred to as “IPP-20AE”. Sufficient nitrogen gas was introduced to raise the internal pressure inside the reactor to 0.1 MPaG, and the internal temperature was raised to 40° C. With the internal temperature maintained at this level, the reaction mixture was stirred at a rate of 300 rotations/second for 24 hours. Following purging of the nitrogen gas from the gas phase, the reactor was opened and a viscous liquid was obtained. This viscous liquid was poured into (a large amount of) methanol to give the fluorine-containing copolymer as a white solid. The obtained solid was dried under vacuum at 65° C., yielding 28.9 g of a white fluorine-containing polymer 1. The “G” in “0.1 MPaG” indicates gauge pressure.

The ratios between the amounts of the monomer units in the obtained fluorine-containing polymer 1 were BVE/PPVE=89/11 (mass ratio) and 88/12 (molar ratio). The weight average molecular weight of the polymer was 60,000.

### Synthesis Example 2

With the exception of adding 28.0 g of BVE and 12.0 g of PPVE, the same method as Synthesis Example 1 was used to obtain 21.6 g of a white fluorine-containing polymer 2.

The ratios between the amounts of the monomer units in the obtained fluorine-containing polymer 2 were BVE/PPVE=70/30 (mass ratio) and 69/31 (molar ratio). The weight average molecular weight of the polymer was 40,000.

### Synthesis Example 3

With the exception of adding 23.0 g of BVE and 17.0 g of PPVE, the same method as Synthesis Example 1 was used to obtain 12.1 g of a white fluorine-containing polymer 3.

The ratios between the amounts of the monomer units in the obtained fluorine-containing polymer 3 were BVE/PPVE=55/45 (mass ratio) and 54/46 (molar ratio). The weight average molecular weight of the polymer was 30,000.

### Synthesis Example 4

With the exception of adding 20.0 g of BVE and 20.0 g of PPVE, the same method as Synthesis Example 1 was used to obtain 10.7 g of a white fluorine-containing polymer 4.

The ratios between the amounts of the monomer units in the obtained fluorine-containing polymer 4 were BVE/PPVE=50/50 (mass ratio) and 49/51 (molar ratio). The weight average molecular weight of the polymer was 27,000.

### Synthesis Example 5

With the exception of adding 12.0 g of BVE and 28.0 g of PPVE, the same method as Synthesis Example 1 was used to obtain 6.6 g of a white fluorine-containing polymer 5.

The ratios between the amounts of the monomer units in the obtained fluorine-containing polymer 5 were BVE/PPVE=40/60 (mass ratio) and 39/61 (molar ratio). The weight average molecular weight of the polymer was 20,000.

### Synthesis Example 6

With the exception of adding 8.0 g of BVE and 32.0 g of PPVE, the same method as Synthesis Example 1 was used to obtain 5.9 g of a white fluorine-containing polymer 6.

The ratios between the amounts of the monomer units in the obtained fluorine-containing polymer 6 were BVE/PPVE=30/70 (mass ratio) and 29/71 (molar ratio). The weight average molecular weight of the polymer was 17,000.

### Synthesis Example 7

With the exception of adding 5.0 g of BVE and 35.0 g of PPVE, the same method as Synthesis Example 1 was used to obtain 5.2 g of a white fluorine-containing polymer 7.

The ratios between the amounts of the monomer units in the obtained fluorine-containing polymer 7 were BVE/PPVE=20/80 (mass ratio) and 19/81 (molar ratio). The weight average molecular weight of the polymer was 15,000.

### Synthesis Example 8

With the exception of adding 3.0 g of BVE and 37.0 g of PPVE, the same method as Synthesis Example 1 was used to obtain 4.7 g of a white fluorine-containing polymer 8.

The ratios between the amounts of the monomer units in the obtained fluorine-containing polymer 8 were BVE/PPVE=10/90 (mass ratio) and 9/91 (molar ratio). The weight average molecular weight of the polymer was 13,000.

### Synthesis Example 9

With the exception of adding 1.0 g of BVE and 39.0 g of PPVE, the same method as Synthesis Example 1 was used to obtain 4.8 g of a white fluorine-containing polymer 9.

The ratios between the amounts of the monomer units in the obtained fluorine-containing polymer 9 were BVE/PPVE=5/95 (mass ratio) and 4/96 (molar ratio). The weight average molecular weight of the polymer was 11,000.

### Synthesis Example 10

With the exception of adding 6.0 g of PDD and 34.0 g of PPVE, the same method as Synthesis Example 1 was used to obtain 13.1 g of a white fluorine-containing polymer 10.

The ratios between the amounts of the monomer units in the obtained fluorine-containing polymer 10 were PDD/PPVE=30/70 (mass ratio) and 32/68 (molar ratio). The weight average molecular weight of the polymer was 30,000.

### Synthesis Example 11

With the exception of adding 20.0 g of PDD and 20.0 g of PPVE, the same method as Synthesis Example 1 was used to obtain 24.0 g of a white fluorine-containing polymer 11.

The ratios between the amounts of the monomer units in the obtained fluorine-containing polymer 11 were PDD/PPVE=65/35 (mass ratio) and 67/33 (molar ratio). The weight average molecular weight of the polymer was 69,700.

### Synthesis Example 12

A pressure-resistant glass reactor with an internal capacity of 100 mL was charged with 13.5 g of BVE, 0.51 g of a dispersion stabilizer (product name: NEWCOL 714-SN, manufactured by Nippon Nyukazai Co., Ltd.), 1.57 g of methanol, and 0.15 g of IPP-20AE. Following insertion of a magnetic stirring bar, the gas phase was replaced with nitrogen. The internal temperature was raised to and then maintained at 40° C., while the reaction mixture was stirred at a rate of 300 rotations/second for 24 hours. The internal temperature was then further raised to and maintained at 50° C., while the reaction mixture was stirred at a rate of 300 rotations/second for a further 6 hours. The reactor was then opened, yielding an aqueous mixed liquid containing a white powder. The white powder was recovered by filtration, and then washed with methanol and water. The thus obtained solid fraction was collected, and then dried under vacuum at 100° C., yielding 12.5 g of a white fluorine-containing polymer 12. The weight average molecular weight of the polymer was 100,000.

### Synthesis Example 13

With the exception of adding 32.0 g of AVE and 8.0 g of PPVE, the same method as Synthesis Example 1 was used to obtain 28.4 g of a fluorine-containing polymer 13 that was partially colored light brown.

The ratios between the amounts of the monomer units in the obtained fluorine-containing polymer 13 were AVE/PPVE=89/11 (mass ratio) and 91/9 (molar ratio). The weight average molecular weight of the polymer was 58,000.

### Synthesis Example 14

With the exception of adding 14.4 g of AVE and 25.6 g of PPVE, the same method as Synthesis Example 1 was used to obtain 9.8 g of a fluorine-containing polymer 14 that was colored very slightly brown.

The ratios between the amounts of the monomer units in the obtained fluorine-containing polymer 14 were AVE/PPVE=40/60 (mass ratio) and 43/57 (molar ratio). The weight average molecular weight of the polymer was 27,000.

### Synthesis Example 15

With the exception of adding only 40.0 g of PPVE, the same method as Synthesis Example 1 was used to obtain 2.7 g of a white fluorine-containing polymer 15. The weight average molecular weight of the polymer was 8,000.

### Examples 1 to 15

Each of the fluorine-containing polymers 1 to 15 was dissolved in a fluorine-containing solvent to prepare a composition (surface treatment agent) composed of the fluorine-containing polymer and the fluorine-containing solvent. Each composition was prepared with the fluorine-containing polymer representing 10% by mass and the fluorine-containing solvent representing 90% by mass of the total mass of the composition. Novec-7300 as a fluorine-containing solvent was used in Example 12, and Novec-7200 was used in a11 of the other examples. The compositions of the surface treatment agents are shown in Table 1.

TABLE 1

| | Fluorine- | | Fluorine-containing |
|---|---|---|---|
| | containing | Liquid | polymer/liquid |
| | polymer | medium | medium (mass ratio) |
| Example 1 | 1 | Novec-7200 | 10/90 |
| Example 2 | 2 | Novec-7200 | 10/90 |
| Example 3 | 3 | Novec-7200 | 10/90 |
| Example 4 | 4 | Novec-7200 | 10/90 |
| Example 5 | 5 | Novec-7200 | 10/90 |
| Example 6 | 6 | Novec-7200 | 10/90 |
| Example 7 | 7 | Novec-7200 | 10/90 |
| Example 8 | 8 | Novec-7200 | 10/90 |
| Example 9 | 9 | Novec-7200 | 10/90 |
| Example 10 | 10 | Novec-7200 | 10/90 |
| Example 11 | 11 | Novec-7200 | 10/90 |
| Example 12 | 12 | Novec-7300 | 10/90 |
| Example 13 | 13 | Novec-7200 | 10/90 |
| Example 14 | 14 | Novec-7200 | 10/90 |
| Example 15 | 15 | Novec-7200 | 10/90 |

For each of the obtained surface treatment agents, the 5% Td and Tg values for the fluorine-containing polymer, and the liquid repellency and liquid slippability of the coating film were evaluated. The results are shown in Tables 2 and 3.

The composition of the fluorine-containing polymer, the C═C residual rate, and the result of evaluating coloration of the solid fraction are also shown in Tables 2 and 3.

TABLE 2

| | | | Exam- | Exam- | Exam- | Exam- | Exam- | Exam- | Exam- | Exam- | Exam- |
|---|---|---|---|---|---|---|---|---|---|---|---|
| | | | ple 1 | ple 2 | ple 3 | ple 4 | ple 5 | ple 6 | ple 7 | ple 8 | ple 9 |
| Fluorine- | Composition | AVE unit | 0 | 0 | 0 | 0 | 0 | 0 | 0 | 0 | 0 |
| containing | [mass ratio] | BVE unit | 89 | 70 | 55 | 50 | 40 | 30 | 20 | 10 | 5 |
| polymer | | PPVE unit | 11 | 30 | 45 | 50 | 60 | 70 | 80 | 90 | 95 |
| | C═C residual rate [mol %] | | 0 | 0 | 0 | 0 | 0 | 0 | 0 | 0 | 0 |
| Heat | Solid fraction coloration | | none | none | none | none | none | none | none | none | none |
| resistance | 5% Td | Measured value [° C.] | 436 | 420 | 419 | 420 | 426 | 410 | 409 | 412 | 389 |
| | | Evaluation | B | B | B | B | B | B | B | B | C |
| | Tg | Measured value [° C.] | 85 | 73 | 54 | 49 | 45 | 35 | 29 | 27 | 27 |
| | | Evaluation | B | B | B | B | B | B | C | C | C |
| Liquid | Water | Measured value [°] | 108 | 112 | 112 | 113 | 114 | 116 | 116 | 115 | 113 |
| repellency | | Evaluation | C | B | B | B | B | A | A | A | B |
| (contact angle) | n-H.D. | Measured value [°] | 58 | 61 | 63 | 64 | 66 | 67 | 67 | 67 | 67 |
| | | Evaluation | C | B | B | B | A | A | A | A | A |
| Liquid | Water | Measured value [°] | 16 | 16 | 20 | 20 | 19 | 21 | 24 | 30 | 36 |
| slippability | | Evaluation | A | A | A | A | A | A | A | B | B |
| (sliding angle) | n-H.D. | Measured value [°] | 21 | 22 | 35 | 37 | 38 | 38 | 39 | 41 | 43 |
| | | Evaluation | A | A | B | B | B | B | B | C | C |

TABLE 3

| | | | Exam- | Exam- | Exam- | Exam- | Exam- | Exam- |
|---|---|---|---|---|---|---|---|---|
| | | | ple 10 | ple 11 | ple 12 | ple 13 | ple 14 | ple 15 |
| Fluorine- | Composition | AVE unit | 0 | 0 | 0 | 89 | 40 | 0 |
| containing | [mass ratio] | BVE unit | 0 | 0 | 100 | 0 | 0 | 0 |
| polymer | | PPVE unit | 70 | 35 | 0 | 11 | 60 | 100 |
| | | PDD unit | 30 | 65 | 0 | 0 | 0 | 0 |
| | C═C residual rate [mol %] | | 0 | 0 | 0 | 1.7 | 0.6 | 0 |
| Heat | Solid fraction coloration | | none | none | none | partially | partially | none |
| resistance | | | | | | light brown | light brown | |
| | 5% Td | Measured value [° C.] | 401 | 422 | 460 | 383 | 369 | 260 |
| | | Evaluation | B | B | B | C | C | D |
| | Tg | Measured value [° C.] | 71 | 127 | 108 | 56 | 34 | 25 |
| | | Evaluation | B | A | B | B | B | C |
| Liquid | Water | Measured value [°] | 113 | 115 | 103 | 104 | 111 | 112 |
| repellency | | Evaluation | B | A | D | D | B | B |
| (contact angle) | n-H.D. | Measured value [°] | 67 | 68 | 53 | 54 | 64 | 67 |
| | | Evaluation | A | A | D | D | B | A |
| Liquid | Water | Measured value [°] | 18 | 17 | 16 | 30 | 54 | 40 |
| slippability | | Evaluation | A | A | A | B | D | C |
| (sliding angle) | n-H.D. | Measured value [°] | 19 | 24 | 18 | 30 | 65 | 70 |
| | | Evaluation | A | A | A | B | D | D |

The fluorine-containing polymers 1 to 11 each yielded a coating film that exhibited an evaluation of C or better for each of the water contact angle, the n-H.D. contact angle, the water sliding angle and the n-H.D. sliding angle, indicating superior liquid repellency and liquid slippability. Further, the fluorine-containing polymers 1 to 11 suffered no coloration, and had 5% Td and Tg evaluations of C or better, indicating superior heat resistance. Among the polymers, the fluorine-containing polymer 11 which included a PDD unit as the Unit A and had a mass ratio represented by Unit A/Unit B of 65/35 exhibited particularly superior liquid repellency and liquid slippability for the coating film.

In contrast, the fluorine-containing polymer 12 which contained no Unit B exhibited inferior liquid repellency for the coating film.

The fluorine-containing polymer 13, which had the same mass ratio of Unit A/Unit B as the fluorine-containing polymer 1 but had a C═C residual rate that exceeded 0.5 mol % exhibited inferior liquid repellency for the coating film. Further, the coating film had some coloration, and the 5% Td and Tg values were lower than those of the fluorine-containing polymer 1, indicating inferior heat resistance.

The fluorine-containing polymer 14, which had a similar mass ratio of Unit A/Unit B to the fluorine-containing polymer 5 but had a C═C residual rate that exceeded 0.5 mol % exhibited inferior liquid slippability for the coating film. Further, the coating film had some coloration, and the 5% Td and Tg values were lower than those of the fluorine-containing polymer 5, indicating inferior heat resistance.

The fluorine-containing polymer 15 formed from only the Unit B exhibited a high n-H.D. sliding angle, indicating poor liquid slippability for the coating film. Further, the 5% Td value was low, indicating poor heat resistance.

### INDUSTRIAL APPLICABILITY

The fluorine-containing polymer of the present invention can form a coating film having excellent liquid repellency and liquid slippability. The fluorine-containing polymer of the present invention can also form a coating film that also exhibits superior heat resistance. Accordingly, the fluorine-containing polymer of the present invention can be used as a surface treatment agent, a protective film on resins, or a cladding material for optical fiber or the like. More specific examples of the substrate include fibers (such as natural fibers, synthetic fibers, mixed yarn fibers, and glass fibers), fabrics (such as woven fabrics, knitted fabrics, and non-woven fabrics), textile products (including clothing articles (such as sportswear, coats, jackets, work clothing, and uniforms), bags, and industrial materials), and separation membranes (such as filtration membranes, air filters, and ion exchange membranes).

The entire content, including the description, claims and abstract, of Japanese Patent Application No. 2022-109738, filed Jul. 7, 2022, are referenced herein, and are deemed to be incorporated within the description of the present invention.

1: A fluorine-containing polymer, comprising:
a main chain comprising a Unit A having a fluorine-containing aliphatic ring structure; and
a Unit B based on a fluorine-containing monomer b that has at least one type of hetero atom selected from the group consisting of an oxygen atom and a sulfur atom, and does not have the fluorine-containing aliphatic ring structure of the main chain,
wherein a residual rate of polymerizable carbon-carbon double bonds in the fluorine-containing polymer is not more than 0.5 mol %.

2: The fluorine-containing polymer according to claim 1, wherein the Unit A of the main chain is at least one type of unit selected from the group consisting of a unit formed by cyclization polymerization of a diene-based fluorine-containing monomer, and a unit based on a cyclic fluorine-containing monomer.

3: The fluorine-containing polymer according to claim 2, wherein the diene-based fluorine-containing monomer has Formula ma1, CF₂═CF-Q-CF═CF₂, where Q is a perfluoroalkylene group of 1 to 6 carbon atoms which may have an etheric oxygen atom and in which a portion of fluorine atoms may each be substituted with a halogen atom other than a fluorine atom.

4: The fluorine-containing polymer according to claim 3, wherein Q in the Formula ma1 has 2 to 6 carbon atoms.

5: The fluorine-containing polymer according to claim 2, wherein the cyclic fluorine-containing monomer has Formula ma2, 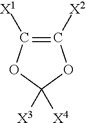
where each of X¹, X², X³ and X⁴ is independently a fluorine atom, a perfluoroalkyl group which may have an etheric oxygen atom, or a perfluoroalkoxy group which may have an etheric oxygen atom, and X³ and X⁴ may be bonded together to form a ring.

6: The fluorine-containing polymer according to claim 1, wherein the fluorine-containing monomer b has Formula b1, CX^{d}X^{e}═CX^{f}—C_{c}F_{2c}—Y^{c}—R^{F}, where each of X^{d}, X^{e} and X^{f} is independently a fluorine atom or a chlorine atom, provided that at least one of X^{d}, X^{e} and X^{f} is a fluorine atom, c is an integer in a range of 0 to 4, Y^{c} an oxygen atom or a sulfur atom, and R^{F} is a perfluoroalkyl group of 1 to 10 carbon atoms.

7: The fluorine-containing polymer according to claim 1, wherein a mass ratio, Unit A/Unit B, is within a range of 5/95 to 90/10.

8: The fluorine-containing polymer according to claim 1, wherein a total amount of the Unit A and the Unit B is within a range of 10 to 100% by mass with respect to a11 units in the fluorine-containing polymer.

9: A composition, comprising:
the fluorine-containing polymer of claim 1; and
a liquid medium.

10: A surface treatment agent, comprising:
the fluorine-containing polymer of claim 1.

11: A surface treatment agent, comprising:
the composition of claim 9.

12: An article prepared by a process comprising coating a substrate with the surface treatment agent of claim 10.

13: The article according to claim 12, wherein the substrate is a sheet-like substrate or a fibrous substrate.

14: The fluorine-containing polymer according to claim 2, wherein the fluorine-containing monomer b has Formula b1, CX^{d}X^{e}═CX^{f}—C_{c}F_{2c}—Y^{c}—R^{F}, where each of X^{d}, X^{e} and X^{f} is independently a fluorine atom or a chlorine atom, provided that at least one of X^{d}, X^{e} and X^{f} is a fluorine atom, c is an integer in a range of 0 to 4, Y^{c} is an oxygen atom or a sulfur atom, and R^{F} is a perfluoroalkyl group of 1 to 10 carbon atoms.

15: The fluorine-containing polymer according to claim 2, wherein a mass ratio, Unit A/Unit B, is within a range of 5/95 to 90/10.

16: The fluorine-containing polymer according to claim 2, wherein a total amount of the Unit A and the Unit B is within a range of 10 to 100% by mass with respect to a11 units in the fluorine-containing polymer.

17: The fluorine-containing polymer according to claim 3, wherein the fluorine-containing monomer b has Formula b1, CX^{d}X^{e}═CX^{f}—C_{c}F_{2c}—Y^{c}—R^{F}, where each of X^{d}, X^{e} and X^{f} is independently a fluorine atom or a chlorine atom, provided that at least one of X^{d}, X^{e} and X^{f} is a fluorine atom, c is an integer in a range of 0 to 4, Y^{c} is an oxygen atom or a sulfur atom, and R^{F} is a perfluoroalkyl group of 1 to 10 carbon atoms.

18: The fluorine-containing polymer according to claim 3, wherein a mass ratio, Unit A/Unit B, is within a range of 5/95 to 90/10.

19: The fluorine-containing polymer according to claim 3, wherein a total amount of the Unit A and the Unit B is within a range of 10 to 100% by mass with respect to a11 units in the fluorine-containing polymer.

20: The fluorine-containing polymer according to claim 4, wherein the fluorine-containing monomer b has Formula b1, CX^{d}X^{e}═CX^{f}—C_{c}F_{2c}—Y^{c}—R^{F}, where each of X^{d}, X^{e} and X^{f} is independently a fluorine atom or a chlorine atom, provided that at least one of X^{d}, X^{e} and X^{f} is a fluorine atom, c is an integer in a range of 0 to 4, Y^{c} is an oxygen atom or a sulfur atom, and R^{F} is a perfluoroalkyl group of 1 to 10 carbon atoms.
